(19) United States
(12) Patent Application Publication
(10) Pub. No.: US 2014/0279378 A1
(43) Pub. Date: Sep. 18, 2014

(54) MODEL PERFORMANCE SIMULATOR

(71) Applicant: BANK OF AMERICA CORPORATION, Charlotte, NC (US)

(72) Inventors: Kasilingam Basker Laxmanan, Newark, DE (US); Sudharani Marupudi, JR., Ashburn, VA (US); Hanli Huang, Newark, DE (US); Surya Ramakrishna Addanki, Bear, DE (US); Alexander A. Shenkar, Roswell, GA (US)

(73) Assignee: BANK OF AMERICA CORPORATION, Charlotte, NC (US)

(21) Appl. No.: 13/800,959

(22) Filed: Mar. 13, 2013

(51) Int. Cl. G06Q 40/02

(52) U.S. Cl. CPC G06Q 40/025
USPC 705/38

(57) ABSTRACT

Model performance measurement in its current state does not take account of a role that strategies play in impacting anticipated model performance. Apparatus and methods are provided that simulate model performance as a function of strategy changes. Apparatus and methods are provided for simulating model performance based on model development assumptions. Traditional model reporting utilizes a mature model performance combined with fully recorded applied strategy change providing reactive model performance analysis after full model performance maturation. For models with not enough time to achieve model performance maturation, a simulated performance metrics such as, a population stability index (“PSI”), Kolmogorov-Smirnov (“K-S”) value or an actual-versus-predicted value (“AvsP”) prior to model performance maturation. The simulated performance metrics may be determined using a model development population and simulating an effect of applying one or more strategy levers to at least a portion of the model development population.

### FIELD OF TECHNOLOGY

Aspects of the disclosure relate to providing apparatus and methods for simulating an impact of strategies on model performance.

### BACKGROUND

A financial institution (hereinafter, “FI”) may offer one or more products or services (hereinafter, “financial products”) to customers. The financial products may permit the customer to borrow funds or incur financial obligations. The financial institution may receive requests for one or more financial products offered by the FI. The FI may grant a portion of the received requests and deny a portion of the received requests. The financial products may be any suitable financial products. Illustrative financial products are shown below in Table 1.

TABLE 1
Illustrative Financial Products.
Illustrative Financial Products

Credit Card
Home Loan/Mortgage
Small Business Loan
Auto Loan
Construction Loan
Education Loan

The FI may monitor customer behavior associated with use of the financial product. Based on the customer behavior, the FI may construct a model to predict future customer behavior associated with use of the financial product. The model may be derived based on one or more characteristics associated with each received request. The model may output a decision whether to grant or deny a request for a financial product based on one or more characteristics of the request. The characteristics may include demographic characteristics.

Each financial product offered by the FI may be associated with a separate model. One or more financial products may share a model. The model may provide an estimate of a number of requests that are likely to generate revenue for the FI. The model may provide an estimate of a number of requests that are likely to generate a loss for the FI.

The model may be associated with one or more performance metrics. The one or more performance metrics may define limits of the model. The one or more performance metrics may be associated with a threshold range. The threshold range may define limits of the model.

For example, a performance metric may correspond to a population stability index (“PSI”). The model may require a PSI within a threshold range to accurately predict future customer behavior associated with use of the financial product.

During a period of time, the FI may wish to apply a strategy to the model. The strategy may include filtering requests based on one or more criteria. The filtering may increase a number of requests considered for approval. The filtering may reduce a number of requests considered for approval.

Applying the strategy may impact one or more performance metrics associated with the model. After applying the strategy, an ability of the model to accurately predict customer behavior may not be determined until some later time. The later time may occur after application of the strategy. The later time may allow one to observe one or more effects of applying the strategy. The later time may allow for customer use of a financial product to reach “maturity.”

For example, the maturity associated with a credit card may correspond to ten billing cycles. After ten billing cycles, the model may determine whether the customer behavior is likely to generate revenue or losses for the FI. The maturity may correspond to one or more quarters of a fiscal year.

It would be desirable therefore to provide apparatus and methods for determining performance metrics associated with applying a strategy to a model without waiting for customer use of a financial product to reach maturity. It would be desirable therefore to provide apparatus and methods for simulating model performance in response to applying the strategy.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative apparatus in accordance with principles of the invention;

FIG. 2 shows an illustrative process in accordance with principles of the invention;

FIG. 3 shows illustrative information in accordance with principles of the invention;

FIG. 4 shows illustrative information in accordance with principles of the invention;

FIG. 5 shows illustrative information in accordance with principles of the invention;

FIG. 6 shows illustrative apparatus in accordance with principles of the invention; and

FIG. 7 shows illustrative information in accordance with principles of the invention.

### DETAILED DESCRIPTION OF THE INVENTION

Apparatus and methods for simulating model performance in response to applying a strategy are provided.

Apparatus may include one or more non-transitory computer-readable media. The media may store computer-executable instructions. The computer-executable instructions, when executed by a processor on a computer system, may perform a method for simulating model performance in response to applying the strategy.

Methods may include calculating a predicted performance metric (“PPM”) of a model. The PPM may indicate a simulated effect of applying the strategy to the model. The simulated effect may correspond to a change in a value of a performance metric associated with the model.

The method may include receiving a model development population. The model development population may include information used to derive the model. For example, the model development population may include requests received by the FI. A request may ask the FI to provide a financial product to the requester. The FI may grant a portion of the requests. The FI may deny a portion of the requests. For each granted request, the FI may monitor a behavior associated with use of the financial product.

The behavior may indicate if, given the number of granted and/or denied requests, the FI has generated revenue. The behavior may indicate if, given the number of granted and/or denied requests the FI has generated a loss. The behavior may include monitoring a customer's use of the financial product. For example, the behavior may include a frequency of missed payments associated with a number of granted requests. The model may be derived based on one or more behaviors exhibited by the model development population.

The method may include receiving a target model performance metric. The target model performance metric may be associated with an expected model performance. For example, the expected model performance metric may correspond to an expected number of granted requests that generate revenue for the FI. The expected model performance metric may correspond to expected revenue generated by a number of granted requests. The expected model performance metric may correspond to an expected number of granted requests that generate a loss for the FI.

The method may include receiving a set of values corresponding to a strategy lever. When the strategy lever is applied to a model, the strategy lever may filter the received requests. For example, the strategy lever may be a range of credit scores. Each request may include a credit score. The requests for a financial product received by the FI may be filtered based on the range of credit scores.

The strategy lever may include granting requests that are associated a credit score within the range of credit scores. The strategy lever may include denying requests that are associated with a credit score within the range of credit scores. The strategy lever may include granting requests that are associated with a credit score outside the range of credit scores. The strategy lever may include denying requests that are associated with a credit score outside the range of credit scores.

The strategy lever may be any suitable strategy lever. The strategy lever may be one of a plurality of strategy levers. Each strategy lever may be associated with a value. For example, a model may be associated with a plurality of model scores. Each model score may correspond to a segment or decile of a model population. The model population may be a model input or a model output. A value of the score may correspond to a segment of the model population. The strategy lever may filter the model population based on the model score value. Illustrative strategy levers and associated values are shown below in Table 2.

TABLE 2
Illustrative strategy levers and associated values.

| Illustrative Characteristic | Illustrative Filter Values |
|---|---|
| Credit Score | >600 |
| Occupation | Professional |
| Months-on-books | ≦24 Months |
| Account Group | BMI Asset |
| Deposits | ≦5K |
| Model Score_1 | <=1443, <=1467, <=1485, |
| | <=1501, <=1516, <=1531 |
| Model Score_2 | 1, 2, 3, 4 |
| Model Score_3 | 1317.00 |
| Distribution Channel | Direct Mail |
| | Online |
| | Print advertisement |
| | Television |
| Time | Month |
| | Day |
| | Year |
| | Time zone |
| Location | Longitude/Latitude |
| | GPS coordinates |
| | Address |
| | Principle place of business |
| Access Channel | Point-of-sale identifier |
| | Automated teller machine |
| | identifier |
| | Online portal identifier |
| | Self-service kiosk |
| | identifier |
| | Mobile device identifier |
| | In person identifier |

The method may include applying the strategy lever to the model development population. The model development population may include information used to derive the model. Applying the strategy lever to the development population may simulate an effect of applying the strategy lever to requests received after deployment of the model. Applying the strategy lever to the development population may simulate an effect of applying the strategy lever to a mature model population. The applying may include filtering the development population based on a set of values corresponding to the strategy lever.

The method may include calculating a first percentage of the development population associated with a first characteristic. The first characteristic may correspond to a strategy lever. The first characteristic may correspond to one or more members of a set of values associated with the strategy lever. The first characteristic may correspond to any suitable value associated with a strategy lever.

For example, each received request may include a credit score. The first characteristic may correspond to range of credit scores. As a further example, each received request may include a demographic characteristic. The first characteristic may correspond to one or more suitable demographic characteristics.

The first percentage may correspond to a portion of received requests that are likely to generate revenue. The first percentage may include a number of granted requests that are corresponding to a simulated model output. The simulated model output may be based on simulating application of a strategy lever. The calculating may include calculating a second percentage of the development population associated with a second characteristic. The second percentage may correspond to a percentage of requests that are likely to generate a loss. The second characteristic may correspond to a strategy lever such as range of credit scores. The second characteristic may correspond to any suitable characteristic, such as a demographic characteristic.

The calculating of the first and second percentages may be based on applying the strategy lever to the development population. For example, the strategy lever may correspond to a threshold credit score. The strategy lever may include filtering requests included in the model development population based on the threshold credit score. The filtering may include simulating a granting of requests that are associated with a credit score greater than or equal to the threshold credit score.

The first percentage may be a first simulated effect of applying a strategy lever to a model development population. The second percentage may be a second simulate effect of applying a strategy lever to a model development population.

The method may include calculating the PPM based on a first difference between the first percentage and the second percentage. The first difference may correspond to an effect of applying the strategy lever to the development population. The effect may be a simulated effect. The first difference between the first percentage and the second percentage may correspond to a net simulated effect of applying a strategy lever to a model development population. The first difference may correspond to a magnitude of the simulated effect.

The calculating of the first and second percentages may be performed prior to completion of a performance maturation period associated with the model. The performance maturation period of the model may be sufficiently long to determine how accurately the model predicts customer behavior. For example, a model may require a passage of three fiscal quarters prior to evaluating a performance of the model. The calculating of the first percentage and/or the second percentage may be performed any time prior to completion of the three fiscal quarters.

The method may include comparing a predicted performance metric (“PPM”) to a target model performance metric. The method may include determining if a second difference between the PPM and the target model performance metric is less than a threshold difference. The threshold difference may correspond to a statistical variance associated with the performance of the model. If the second difference is greater than the threshold difference, applying the strategy lever to the model may render the model unsuitable for use in processing requests for the financial product. The model may be unsuitable for use in processing the requests because the model, when the strategy lever is applied to the model, does not accurately predict customer behavior.

The second difference may be less than the threshold difference. When the second difference is less than the threshold difference, the method may include applying the strategy lever to an incoming model population. When the second difference is less than the threshold difference, performance of the model may not be substantially disrupted by applying the strategy lever. When the second difference is less than the threshold difference, the method may include approving application of the strategy lever to the model.

When the second difference is greater than the threshold difference, the method may include calculating a risk that applying the strategy lever to the model renders the model statistically obsolete. When the second difference is greater than the threshold difference, the method may include displaying a warning message if an attempt is made to apply the strategy lever to the model. When the second difference is greater than the threshold difference, the strategy lever may be made unavailable for application to the model.

The PPM may include a population stability index (“PSI”). The model may require an incoming population that varies within a statistical range. The PPM may indicate whether, after simulating application of the strategy lever to the model, the incoming model population is within the statistical range.

The PPM may include a Kolmogorov-Smirnov (“K-S”) value. The K-S value may correspond to a deviation of model performance based on applying the strategy. The K-S value may correspond to a difference between predicted model performance without application of the strategy and predicted or past model performance including application of the strategy. The K-S value may correspond to a difference between historical model performance without application of the strategy and past model performance including application of the strategy. The K-S value may correspond to any suitable difference in model performance based on applying or removing the strategy lever. The K-S value may be a simulated K-S value calculated based on simulating an effect of the strategy lever on the model development population.

Model performance may be measured based on a percentage of granted requests that are past due. Model performance may be measured based on a percentage of granted requests that are in good standing. Good standing may correspond to a granted request that generates revenue for the FI. Good standing may correspond to a granted request that does not generate revenue yet does not generate a loss.

The PPM may include an Actual-versus-Predicted (“AvsP”) value. The AvsP may correspond to a relationship linking a current status of one or more customer accounts to a predicted status of the one or more customer accounts. The customer account may be associated with a granted request for a financial product. A current status of the account may be based on customer use of the financial product. The status of the one or more accounts may include a balance owed on the account or any suitable status associated with the account. The AvsP may correspond to an actual number of accounts associated with a balance greater than ninety-day past due (90 bpd) compared to a predicted number of accounts associated with 90 bpd.

The strategy lever may be one of a plurality of strategy levers. At least one of the plurality of strategy levers may correspond to a plurality of credit scores. Applying the strategy lever to the model may include filtering requests for a financial product based on the plurality of credit scores. The filtering may include granting a request if the request includes at least one of the plurality of credit scores.

The strategy lever may be one of a plurality of strategy levers. When the strategy lever is one of a plurality of strategy levers, the method may include calculating a PPM for each of the plurality of strategy levers.

Apparatus may include a model performance simulator. The model performance simulator may be configured to determine statistical obsoleteness of a model. The simulator may include a non-transitory computer readable medium. The non-transitory computer readable medium may have computer readable program code embodied therein.

The simulator may include a processor. The processor may be configured to execute the computer readable program code embodied in the non-transitory computer readable medium.

The computer readable program code may cause the simulator to receive a plurality of values corresponding to a strategy lever. The strategy lever may correspond to at least one credit score. The code may cause the simulator to determine a simulated effect of integrating the strategy lever into the model. Integrating the strategy lever into the model may include applying the strategy lever to incoming and/or development model populations. The simulated effect may be determined prior to deployment of the model.

The code may cause the simulator to calculate a model performance metric based on the simulated effect of integrating the strategy lever into the model. The code may cause the simulator to compare the model performance metric to a target model performance metric. When a difference between the model performance metric and the target performance metric exceeds a threshold, the code may cause the computer to associate the strategy lever with a risk of rendering the model statistically obsolete. When the difference exceeds the threshold, applying the strategy lever to the model may disrupt one or more assumptions underlying the model. The model may not accurately predict customer behavior when one or more assumptions underlying the model are disrupted.

The model performance metric may correspond to a population stability index (“PSI”). The model performance metric corresponds to a Kolmogorov-Smirnov (“K-S”) value. The model performance metric may correspond to a result of an actual-versus-predicted (“AvsP”) analysis.

The AvsP may correspond to a predicted number of accounts carrying a balance that is more than ninety-days past due (“90 bpd”). The target performance metric may correspond to a target number of customer accounts that are associated with a 90 bpd.

Methods may include determining a simulated model performance metric. The method may include receiving a model. The model may be associated with a development population. The model may be derived based on the development population. The model may be configured to predict future customer behavior based on the customer behavior exhibited by the development population.

The model may be configured to receive an input population. The input population may include a plurality of requests for a financial product. For example, the input population may correspond to a plurality of credit card applicants. The plurality of credit card applicants may be received after a maturation of the development population. The financial product may be a credit card, a loan, or any suitable financial product. Illustrative financial products are shown above in Table 1.

The model may be configured to generate an output. For example, each member of the input population may be associated with a credit score. The output may correspond to a percentage of the input population associated with a credit card account in good standing. The output may correspond to a percentage of the input population currently carrying a balance on the credit card account. The output may correspond to any suitable customer behavior associated with the financial product.

The method may include receiving an input population filter. The input population filter may include a plurality of values. The filter may identify one or more members of a model population that are associated with the value. The method may include applying the filter to at least a portion of the development population. The method may include applying the filter to at least a portion of the development population and at least a portion of the input population.

Applying the filter to at least a portion of the development population may simulate an effect of applying the filter to the incoming population. Applying the filter to the development population may simulate an anticipated effect of applying the filter to the input population. For example, the filter may be configured to reduce a size of the input population. The filter may be configured to increase the size of the input population. Applying the filter to the development population may indicate if the filter will have the desired effect on the input population. Applying the filter to the development population may indicate if the filter will have an effect greater than the desired effect on the input population.

The method may include determining a plurality of performance metrics. At least one of the plurality of performance metrics may be determined based on comparing: (1) an output generated by applying the filter to at least the portion of the development population, and (2) a target output associated with the model. The target output may correspond to a target monetary value of past due balances associated with the model. The target value may be a number, percentage, or any suitable target value associated with the model.

The development population may be a “mature” model population. In a mature model population, each member of the population may be associated with one or more characteristics that have yet to be determined for each member of the input population. For example, a past due balance may not appear earlier than three months after granting the request. The development population may include customers that have used the financial product for at least three months. The development population may include customers that have used the financial product for at least the maturation period associated with the financial product.

The method may include adjusting the filter. The adjusting of the filter may include adjusting one or more values associated with the filter. The filter may be adjusted when at least one of the simulated performance metrics corresponds to a shifting of the model output. The filter may be adjusted when the shifting of the output is greater than a threshold deviation from a target output. When the output shifts more than a threshold value away from the target output, the filtering may be disrupting one or more assumptions underlying a derivation of the model. When one or more assumptions of the model are disrupted, the model may not provide an accurate prediction of a behavior of the input population.

The method may include retrieving the model and development population from a first source. The first source may be a first unit of the FI. The first unit may be responsible for deriving the model. The method may include retrieving the filter from a second source. The second source may be a second unit of the FI. The second unit may be different from the first unit. The second unit may include the first unit. The second unit may be tasked with granting/denying requests for a financial product.

The method may include selecting the filter from a plurality of filters. The plurality of filters may include filters based on any suitable characteristic of a request for a financial product. A filter may be a strategy lever. Illustrative strategy levers are shown above in Table 2.

The applying of the filter may include applying at least two of the plurality of filters to the at least a portion of the development population. Applying the filter to a portion of the development may simulate an effect of applying the filters to an incoming population. Applying the filter to the development population may simulate performance of the model when a now-immature incoming population later matures.

Applying the filter may test a robustness of the model to accurately predict a behavior of the input population. The behavior may include customer behavior such as a failure to satisfy obligations or any suitable behavior exhibited by a customer using the financial product.

The plurality of simulated performance metrics may include a population stability index (“PSI”). The plurality of simulated performance metrics may include a Kolmogorov-Smirnov (“K-S”) value. The plurality of simulated performance metrics may include an actual-versus-predicted value (“AvsP”).

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 115. Server 101 may include one or more receiver modules, server modules and processors that may be configured to receive requests for a financial product, receive model populations, apply a filter and/or strategy levers, identify effects of applying the filter and/or strategy lever, compare values and perform any other suitable tasks related to simulating an effect of applying the filter and/or strategy lever to a model population.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 111. Alternatively, some or all of server 101 computer executable instructions may be embodied in hardware or firmware (not shown). As described in detail below, database 111 may provide storage for model populations, characteristics associated with each received request, filter values, threshold values, strategy levers, simulated effects, requests for a financial product and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (“SMS”), and voice input and speech recognition applications.

Computing device 101 and/or terminals 141 or 151 may also be mobile terminals including various other components, such as a battery, speaker, and antennas (not shown).

Terminal 151 and/or terminal 141 may be portable devices such as a laptop, smart phone, tablet, or any other suitable device for storing, transmitting and/or transporting relevant information.

Any information described above in connection with database 111, and any other suitable information, may be stored in memory 115.

One or more of applications 119 may include one or more algorithms that may be used to process requests for a financial product, receive model populations, apply a filter and/or strategy levers, identify effects of applying the filter and/or strategy lever, calculate model performance metrics, generate model outputs, compare values and perform any other suitable tasks related to simulating an effect of applying the filter and/or strategy lever to a model population and perform any other suitable tasks related to simulated model performance.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, “smart phones,” tablets, programmable consumer electronics, network PCs, minicomputers, mainframe computers, distributed computing environments that include any of the above systems or devices, and the like. In a distributed computing environment, devices that perform the same or similar function may be viewed as being part of a “module” even if the devices are separate (whether local or remote) from each other.

The invention may be described in the general context of computer-executable instructions, such as program modules, being executed by a computer. Generally, program modules may include routines, programs, objects, components, data structures, etc., that perform particular tasks or store or process data structures, objects and other data types. The invention may also be practiced in distributed computing environments where tasks are performed by separate (local or remote) processing devices that are linked through a communications network. In a distributed computing environment, program modules may be located in both local and remote computer storage media including memory storage devices.

FIG. 2 shows illustrative process 200. For the sake of illustration, the steps of the illustrated process will be described as being performed by a “system.” The “system” may include one or more of the features of the apparatus shown in FIG. 1 and/or any other suitable device or approach. The “system” may be provided by an entity. The entity may be an individual, an organization or any other suitable entity. For example, the entity may be a financial institution or an agent of a financial institution.

FIG. 2 shows an illustrative process for determining robustness of a model in response to applying one or more strategy levers. At step 201, the system may receive model validation data tables. The model validation data tables may include the model outputs. The model outputs may be generated by the model in response to receiving an input population. A model output may include a first percentage of the input population associated with a first characteristic. A model output may be a second percentage of a model input population associated with a second characteristic. The model output may be a difference between the first and second percentages.

The model validation tables may include one or more performance metric values. The one or more performance metric values may each be associated with a threshold range of values. The model may accurately predict behavior of an input population when the performance metric values associated with the input population are within the threshold range of values. The performance metric values may be values associated with any suitable performance metric. Illustrative performance metrics may include PSI values, K-S values and results of AvsP analyses.

At step 203, the system may receive one or more strategy levers. The strategy levers may include filtering criteria. The criteria may be any suitable criteria such as the strategy levers and associated values listed above in Table 2. The strategy levers may be associated with the model validation tables. The strategy levers may be developed for use with one or more different models. The strategy levers may be received from a business partner. Receiving the strategy levers may include receiving data source and variable names associated with the lever.

At step 205, the system may receive model inputs. The model inputs may include a model development population. The model inputs may include a model input population. The model inputs may include customer requests for a financial product. The model inputs may include granted requests and/or denied requests. The model inputs may include characteristics associated with each received request. The model inputs may be refreshed periodically. The time period for refreshing the model inputs may have any suitable length, such as one hour, one day, seven days, two weeks, thirty days, one-month, three months, six months, one year, two years or five years.

At step 207, the information received by the system at steps 201-205 may be input into a data analysis engine. The data analysis engine may merge the information received at steps 201-205. The information may be merged into a single table. Based on the merged data, the data analysis engine may generate audit reports on one or more strategy levers. An audit report may include statistics confirming normal execution of computer executable code. For example, the audit report may confirm normal execution of code based on calculating distribution of a categorical variable and/or a percentage of missing values in input data.

Process 200 may include optional step 209. At step 209, the system may develop rule based strategy variables. The strategy variables may include a plurality values. The plurality of values may correspond to one or more strategy levers. Each strategy lever included in the plurality may be identified an analyzed in the audit reporting. A rule based strategy variable may a probability of a granted request being associated with balance past due (BPD). The rule based strategy variable may be used to define a target model output. For example, the target output may correspond to BPD<=0.4. The strategy variable may be a yes/no variable. In the example above, BPD<=0.4 may correspond to a “yes” and BPD>0.4 may correspond to a “no.”

The yes/no strategy variable may include a threshold limit associated with the strategy. The threshold limit may be a performance metric associated with a model. If a simulated effect of applying a strategy lever to the model results in a performance metric above the threshold limit, the strategy variable may be a “no,” and not applied to the model. If a simulated effect of applying a strategy lever to the model results in a performance metric within the threshold limit, the strategy variable may be a “yes,” and applied to the model.

Process 200 may include optional step 211. At step 211, the system may develop optimization variables. The optimization variables may identify an optimum filter value and/or strategy lever value. An optimization variable may be designed to optimize an output of the model. The output may be optimized based on a desired number of received requests, number of granted requests, revenue associated by granted requests or any suitable model input and/or output.

At step 213, the system may form a dataset, for a model. The dataset may include the validation metrics and the strategy levers. At step 215, a simulation server generates a simulated effect of the aggregated information on a model.

Generating the simulated effect may include, at step 217, simulating application of one or more strategy levers to a model population and assessing model performance in response to the applying.

Generating the simulated effect may include, at step 219, changing model inputs and simulating model performance in response to the change. Changing the model inputs may include selecting, as an input to the model, a portion of a model development population, a portion of the input population and/or a combination of the development population and input population.

The simulated effect may include, at step 221, simulating application of optimization based strategy levers. The optimization based strategy levers may be designed to filter the input population of a model. The optimization based strategies may be designed to filter the input population of a model to achieve an optimized output from the model.

FIG. 3 shows illustrative time-line 300. Monitoring and tracking (“M&T”) arrow 301 shows a direction of time associated with traditional model M&T analysis. Traditional M&T analysis looks backward in time at historical customer behavior predicted by a model. MPS arrow 303 shows a direction of time associated with model performance simulation. Model performance simulation may be a model output corresponding to a prediction of customer behavior.

Time-line 300 includes duration A. During duration “A,” data corresponding to a model development population is gathered by a financial institution (“FI”). After duration A, a model is developed based on the development population. The model may be designed to predict customer behavior associated a financial product. The model may be deployed during duration B. Duration B corresponds to three-quarters of a year. After duration B, performance of the model may be evaluated by calculating one or more performance metrics. Time-line 300 shows that at the end of duration B, a K-S value is calculated.

At point C, a first strategy change is deployed. A simulated effect of deploying the strategy change may be determined at point C. Point C may be at a point prior to maturation of the input population received at point C. An actual effect of deploying the strategy change on the input population received at point C may not be available until point E.

As a further example, a second strategy change is deployed at point D. A simulated effect of deploying the second strategy change may be calculated at point D. An actual effect of deploying the second strategy change may not be observable until point F.

FIG. 4 shows illustrative graph 400. Graph 400 shows a plot of simulated K-S values. The simulated K-S values may be generated based on simulating application of a strategy lever to a total number of requests. The K-S values may be determined based on a relationship between decile segments of a number of granted requests for a financial product (horizontal axis) and a total number of requests (vertical axis). Each decile segment may correspond to requests associated with a characteristic. The total number of requests may be a total number of received requests. The total number of requests may be a total number of granted or denied requests.

Graph 400 shows a first plot in broken line. The broken-line plot corresponds to the simulated K-S values associated with requests that generate a loss for the FI. Graph 400 also shows a second plot in solid line. The solid line plot corresponds to simulated K-S values associated with requests that do not generate a loss for the FI. The solid line plot may correspond to simulated K-S values associated with requests that generate a profit for the FI.

FIG. 5 shows illustrative graph 500. Graph 500 shows a plot of simulated Actual vs. Predicted (“AvsP”) metrics for a deployed strategy change. Graph 500 shows a first plot in broken line. The first plot corresponds to a simulated number of granted requests that will actually generate a loss for a FI. Graph 500 shows a second plot in solid line. The second plot corresponds to a simulated number of granted requests that are predicted to generate a loss for the FI. The simulated AvsP may correspond to a difference between the actual and predicted numbers. The difference may correspond to an area bounded by the first and second plots.

FIG. 6 shows illustrative graph 600. Graph 600 shows a plot of an Actual vs. Predicted (“AvsP”) metric after a full maturation of a number of granted requests. Full maturation may be achieved after passage of a duration of time. The duration of time may allow a FI to observe customer behavior associated with a number of granted requests. Each of the “mature” granted requests may generate a loss for the FI.

Graph 600 includes a first plot in broken-line. The first plot corresponds to a percentage of granted requests that generated a loss for the FI. Graph 600 includes a second plot in solid line. The second plot corresponds to a percentage of granted requests predicted to generate a loss for the FI. The predicted percentage may be determined by a model. For example, the predicted percentage may be an output of the model.

An AvsP metric associated with fully mature requests may correspond to a difference between the first number of granted requests represented by the broken-line and the second number of requests represented by the solid-line. The difference may correspond to an area bounded by the broken and solid lines.

A difference between the simulated AvsP (shown in FIG. 5) and actual AvsP (shown in FIG. 6) may indicate a degree of accuracy in simulated an effect of a strategy change on a model.

FIG. 7 shows illustrative graph 700. Graph 700 includes a first plot in broken line. The first plot corresponds to a current number of requests (vertical axis) associated with a range of credit scores (horizontal axis). The current number of requests may be received requests. The current number of requests may be granted requests. The current number of requests may be denied requests. The current number of requests is determined during a time period when a strategy lever is applied to a model. Based on the current number of requests a current population stability index (“PSI”) of a model may be calculated.

Each range of credit scores may correspond to a strategy lever that may be applied to a model. The PSI value may be determined based on a number of requests corresponding to a selected range of credit scores.

Graph 700 includes a second plot shown in solid line. The second plot corresponds to a predicted number of requests associated with the range of credit scores. The model may be derived based on the predicted number of requests. The predicted number of requests may form an underlying assumption of the model. The predicted number of requests may be determined based on analysis of a fully mature development population. The predicted number of requests may be determined based on simulating an effect of a strategy lever on a model. Based on the predicted number of requests, a population stability index (“PSI”) may be determined.

A difference between the current number of requests and the predicted number of requests may be determined. The difference between the current and predicted number of requests may be determined based on an area bounded by the first and second plots.

A difference between the current PSI and predicted PSI may be determined. The difference between the current and the predicted PSI may indicate whether applying the strategy lever to the model disrupts an assumption underlying the model. For example, if the current PSI is within a range of the anticipated PSI, the strategy lever is unlikely to disrupt performance of the model.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for a model performance simulator have been provided. Persons skilled in the art will appreciate that the present invention can be practiced by other than the described embodiments, which are presented for purposes of illustration rather than of limitation. The present invention is limited only by the claims that follow.

1-15. (canceled)

16. A method for determining a predicted model performance metric, the method comprising:
receiving a model associated with a development population, the model configured to:
receive an input population comprising a plurality of credit card applicants, each credit card applicant being associated with a credit score; and
generate an output corresponding to a percentage of the input population associated with a past due credit card balance;
receiving an input population filter;
applying the filter to at least a portion of the development population;
determining a plurality of performance metrics based on comparing:
(1) the output generated by applying the filter to at least a portion of the development population; and
(2) a target number of number of accounts associated with the past due credit card balance; and
adjusting the filter when at least one of the simulated performance metrics is associated with a shifting of the output that is greater than a threshold value deviation from the target number.

17. The method of claim 16 further comprising:
retrieving the model and development population from a first source; and
retrieving the filter from a second source.

18. The method of claim 16 further comprising selecting the filter from a plurality of filters.

19. The method of claim 18 wherein the applying comprises applying at least two of the plurality of filters to the at least a portion of the development population.

20. The method of claim 16 wherein at least one of the plurality of simulated performance metrics is;
a population stability index (“PSI”);
a Kolmogorov˜Smirnov (“K-S”) value; or
an actual-versus-predicted value (“AvsP”).

21. A method of calculating a predicted performance metric (“PPM”) of a model, the method comprising:
receiving a model development population;
receiving a target model performance metric;
receiving a set of values corresponding to a filter;
applying the filter to the model development population;
based on the applying, calculating:
a first percentage of the development population associated with a first characteristic; and
a second percentage of the development population associated with a second characteristic;
calculating the PPM based on a first difference between:
the first percentage; and
the second percentage;
comparing the PPM to the target model performance metric;
determining if a second difference between the PPM and the target model performance metric is less than a threshold difference; and
when the second difference is less than the threshold difference, applying the filter to incoming model population.

22. The method of claim 21 wherein the PPM comprises a population stability index (“PSI”).

23. The method of claim 21 wherein the PPM comprises a Kolmogorov-Smirnov (“K-S”) value.

24. The method of claim 21 wherein the PPM comprises an Actual-versus-Predicted (“AvsP”) value.

25. The method of claim 21 wherein:
the filter is one of a plurality of filters; and
at least one of the plurality of filters corresponds to a plurality of credit scores.

26. The method of claim 21 wherein the calculating is performed prior to expiration of a performance maturation period associated with the model.

27. The method of claim 24 wherein the AvsP value corresponds to a number of accounts associated with a ninety-day balance past due (90 bpd) compared to a predicted number of accounts associated with the 90 bpd.

28. The method of claim 21 further comprising, when the second difference is greater than the threshold difference, calculating a risk that applying the filter to the model corrupts an output of the model.

29. The method of claim 21 further comprising, when the filter is one of a plurality of filters, calculating the PPM for each of the plurality of filters.

30. A model performance simulator that is configured to predict an accuracy of a model output, the simulator comprising:
a non-transitory computer readable medium having computer readable program code embodied therein; and
a processor configured to execute the computer readable program code;
the computer readable program code comprising:
computer readable code for causing the simulator to receive a plurality of values corresponding to a filter;
computer readable code for causing the simulator to determine, prior to deployment of the model, a simulated effect of integrating the filter into the model;
computer readable code for causing the simulator to calculate a model performance metric based on the simulated effect of the integrating;
computer readable code for causing the simulator compare the model performance metric to a target model performance metric; and
computer readable code for causing the simulator, when a difference between the model performance metric and the target performance metric exceeds a threshold, to associate the filter with a risk of an inaccurate model output.

31. The simulator of claim 30, wherein the model performance metric corresponds to a population stability index (“PSI”).

32. The simulator of claim 30 wherein the model performance metric corresponds to a Kolmogorov-Smirnov (“K-S”) value.

33. The simulator of claim 30 wherein the model performance metric corresponds to an actual-versus-predicted (“AvsP”) value.

34. The simulator of claim 33 wherein:
the AvsP value corresponds to a predicted number of accounts associated with a ninety-day balance past due (90 bpd); and
the target performance metric corresponds to a target number of accounts associated with the 90 bpd.

35. The simulator of claim 30 wherein the filter corresponds to at least one credit score.
